(19) United States
(12) Patent Application Publication
(10) Pub. No.: US 2010/0227607 A1
(43) Pub. Date: Sep. 9, 2010

(54) SYSTEMS AND METHODS FOR AUTOMATED MOBILE DEVICE TESTING WITH EMULATED FIELD MOBILITY CONDITIONS IN REAL-TIME

(75) Inventors: Lynard S. Lorion, San Diego, CA (US); Vusthla Sunil Reddy, San Diego, CA (US)

Correspondence Address: QUALCOMM INCORPORATED, 5775 MOREHOUSE DR., SAN DIEGO, CA, 92121, US

(73) Assignee: QUALCOMM INCORPORATED, San Diego, CA (US)

(21) Appl. No.: 12/399,506

(22) Filed: Mar. 6, 2009

(51) Int. Cl. H04W 24/00

(52) U.S. Cl. 455/425

(57) ABSTRACT

An automated mobile device testing system is described. The automated mobile device testing system may include one or more base stations. The base stations may serve one or more mobile devices. The automated mobile device testing system may also include a rotating unidirectional antenna. The automated mobile device testing system may further include a radio frequency (RF) controlled environment. The automated mobile device testing system may also include one or more mobile devices to be tested. The automated mobile device testing system may further include automated testing equipment.

### TECHNICAL FIELD

The present disclosure relates generally to communication systems. More specifically, the present disclosure relates to systems and methods for automated mobile device testing with emulated field mobility conditions in real-time.

### BACKGROUND

Wireless communication devices have become smaller and more powerful in order to meet consumer needs and to improve portability and convenience. Consumers have become dependent upon wireless communication devices such as cellular telephones, personal digital assistants (PDAs), laptop computers, and the like. Consumers have come to expect reliable service, expanded areas of coverage, and increased functionality. A wireless communication device may be referred to as a mobile station, a subscriber station, an access terminal, a remote station, a user terminal, a terminal, a subscriber unit, user equipment, etc. The term “mobile device” will be used herein. A wireless communication device may be configured for use in a Universal Mobile Telecommunications System (UMTS).

A wireless communication system may provide communication for a number of cells, each of which may be serviced by a base station. A base station may be a fixed station that communicates with mobile devices. A base station may alternatively be referred to as an access point, a Node B, or some other terminology.

A mobile device may communicate with one or more base stations via transmissions on the uplink and the downlink. The uplink (or reverse link) refers to the communication link from the mobile device to the base station, and the downlink (or forward link) refers to the communication link from the base station to the mobile device. A wireless communication system may simultaneously support communication for multiple mobile devices.

Wireless communication systems may be multiple-access systems capable of supporting communication with multiple users by sharing the available system resources (e.g., bandwidth and transmit power). Examples of such multiple-access systems include code division multiple access (CDMA) systems, time division multiple access (TDMA) systems, frequency division multiple access (FDMA) systems, orthogonal frequency division multiple access (OFDMA) systems, and spatial division multiple access (SDMA) systems.

New mobile devices may undergo extensive testing to gauge the stability of these wireless devices. Such testing may require field mobility conditions in real-time to test the mobile devices in various scenarios. Typically, such testing has been carried out with dedicated human resources driving an automobile in the field while testing mobile devices. The number of necessary resources increases with the number of mobile devices tested. Furthermore, it is difficult to perform continuous testing over long periods of time including weekends and holidays if the testing is performed by humans. Benefits may be realized by automated testing of mobile devices in emulated field mobility conditions in real-time.

### BRIEF DESCRIPTION OF THE DRAWINGS

FIG. 1 illustrates a wireless communication system for automated mobile device testing that includes multiple base stations and multiple mobile devices;

FIG. 2 is a block diagram of an RF controlled environment and a computer system as part of an automated mobile device testing system;

FIG. 3 is a block diagram illustrating an alternate RF controlled environment as part of an automated mobile device testing system;

FIG. 4 is a flow diagram illustrating a method for automated testing of a mobile device with field mobility conditions in real-time;

FIG. 4A illustrates means-plus-function blocks corresponding to the method of FIG. 4;

FIG. 5 is a flow diagram of a more detailed method for automated testing of a mobile device with field mobility conditions in real-time;

FIG. 5A illustrates means-plus-function blocks corresponding to the method of FIG. 5;

FIG. 6 is a block diagram illustrating various physical testing that the automated mobile device testing system may perform on a mobile device;

FIG. 7 is a block diagram illustrating the various software testing that the automated mobile device testing system may perform on a mobile device;

FIG. 8 is a block diagram illustrating a database for use in the present systems and methods;

FIG. 9 is a block diagram of an automated mobile device testing system with a rotating unidirectional antenna; and

FIG. 10 illustrates certain components that may be included within a computing device that may be used within the present systems and methods.

### DETAILED DESCRIPTION

An apparatus for automated mobile device testing is disclosed. The apparatus includes a processor and memory in electronic communication with the processor. Executable instructions are stored in the memory. A mobile device in a radio frequency (RF) controlled environment is communicated with using RF signals that emulate field mobility conditions in real-time. Automated testing is performed on the mobile device. Testing results are recorded from the automated testing in a database. The instructions may also be executable to analyze the testing results to determine the stability of the mobile device.

The apparatus may include a rotating unidirectional antenna that receives the RF signals that emulate field mobility conditions in real-time. The apparatus may also include an RF signal distributor and a bidirectional amplifier.

The apparatus may include an RF controlled environment antenna. Communicating with the mobile device may be accomplished using the RF controlled environment antenna within the RF controlled environment. The RF controlled environment may be an environment where only certain RF signals are present.

The automated testing on the mobile device may be performed using physical interaction. The physical interaction may simulate user interaction with the mobile device. In addition, the automated testing on the mobile device may be performed using software interaction

A method for automated mobile device testing is disclosed. A mobile device in a radio frequency (RF) controlled environment is communicated with using RF signals that emulate field mobility conditions in real-time. Automated testing is performed on the mobile device. Testing results are recorded from the automated testing in a database.

The RF signals that emulate field mobility conditions in real-time may be received from one or more base stations using a rotating unidirectional antenna.

An apparatus for automated mobile device testing is disclosed. The apparatus may include means for communicating with a mobile device in a radio frequency (RF) controlled environment using RF signals that emulate field mobility conditions in real-time. The apparatus may include means for performing automated testing on the mobile device. The apparatus may include means for recording testing results from the automated testing in a database.

A computer-program product for automated mobile device testing is also disclosed. The computer-program product includes a computer-readable medium having instructions thereon. The instructions may include code for communicating with a mobile device in a radio frequency (RF) controlled environment using RF signals that emulate field mobility conditions in real-time. The instructions may include code for performing automated testing on the mobile device. The instructions may include code for recording testing results from the automated testing in a database.

An automated mobile device testing system is disclosed. The automated mobile device testing system may include one or more base stations for serving one or more mobile devices. The automated mobile device testing system may include a rotating unidirectional antenna. The testing system may include a radio frequency (RF) controlled environment. One or more mobile devices may be tested using the system.

The automated mobile device testing system may include automated testing equipment. The automated testing equipment may simulate user interaction with the one or more mobile devices to be tested. The automated testing equipment may perform physical testing and/or software testing.

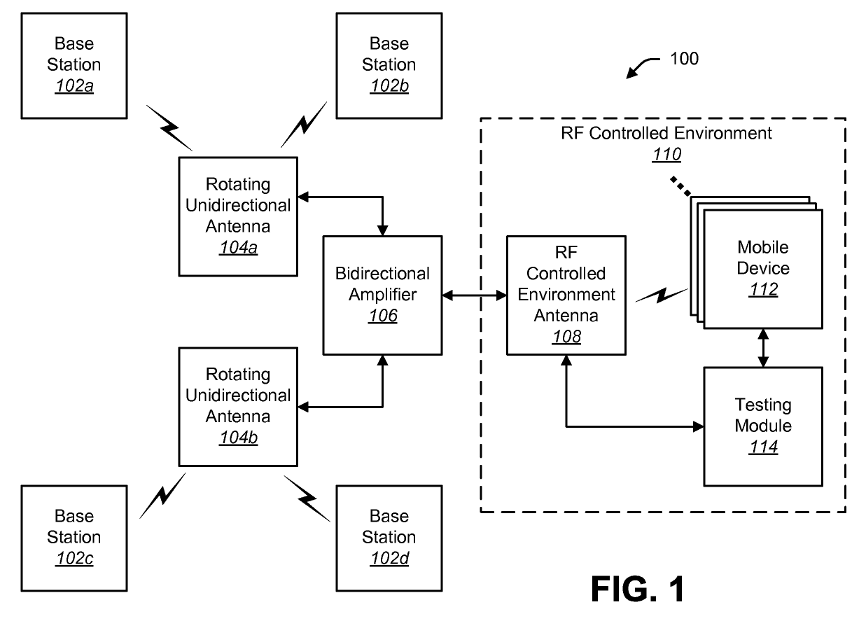

FIG. 1 illustrates an automated mobile device testing system 100 that includes multiple base stations 102 and multiple mobile devices 112. A mobile device 112 may also be called, and may contain some or all of the functionality of, a terminal, an access terminal, a user equipment, a subscriber unit, a station, etc. A mobile device 112 may be a cellular phone, a personal digital assistant (PDA), a wireless device, a wireless modem, a handheld device, a laptop computer, etc.

A base station 102 is a station that communicates with one or more mobile devices 112. A base station 102 may also be called, and may contain some or all of the functionality of, an access point, a Node B, an evolved Node B, etc. Each base station 102 provides communication coverage for a particular geographic area. The term “cell” can refer to a base station 102 and/or its coverage area depending on the context in which the term is used.

A mobile device 112 may communicate with zero, one, or multiple base stations 102 on the downlink (DL) and/or uplink (UL) at any given moment. The downlink (or forward link) refers to the communication link from the base stations 102 to the mobile devices 112, and the uplink (or reverse link) refers to the communication link from the mobile devices 112 to the base stations 102.

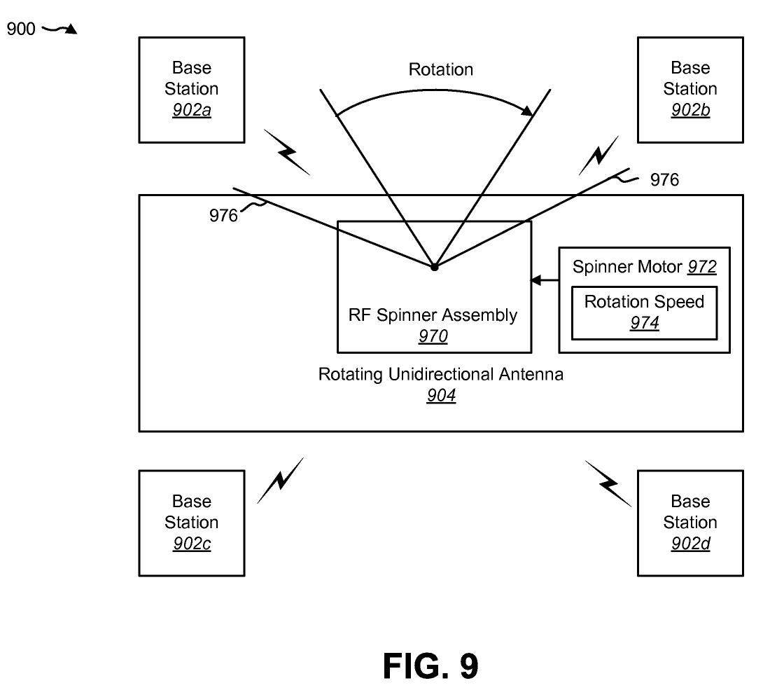

The automated mobile device testing system 100 may include one or more rotating unidirectional antennas 104. Each rotating unidirectional antenna 104 may be in electronic communication with one or more base stations 102. Rotating unidirectional antennas 104 are discussed in more detail below in relation to FIG. 9. A rotating unidirectional antenna 104 may send uplink communications to one or more base stations 102 and receive downlink communications from one or more base stations 102. The rotating unidirectional antenna 104 may relay downlink communications received from one or more base stations 102 to one or more mobile devices 112. The downlink communications may be amplified by a bidirectional amplifier 106 to compensate for signal losses such as cable loss. The rotating unidirectional antenna 104 may also relay uplink communications received from one or more mobile devices 112 to one or more base stations 102. The uplink communications may be amplified by the bidirectional amplifier 106 to compensate for signal losses prior to being sent to one or more base stations 102 by the rotating unidirectional antenna 104.

After amplification by the bidirectional amplifier 106, the downlink communications may be broadcast by a radio frequency (RF) controlled environment antenna 108 within an RF controlled environment 110 to one or more mobile devices 112 within the RF controlled environment 110. The RF controlled environment 110 may be an environment where only certain RF signals are present. The RF controlled environment 110 may be a room, a box, a building, or any other enclosure where RF signals can be controlled. The RF controlled environment 110 may block undesired RF signals from reaching the mobile devices 112 in the RF controlled environment 110 while allowing other RF signals to reach the mobile devices 112.

A testing module 114 within the RF controlled environment 110 may perform testing on the one or more mobile devices 112 within the RF controlled environment 110. For example, the testing module 114 may perform physical testing and software testing on the mobile devices 112. The testing module 114 may automatically perform testing on the mobile devices 112. For example, the testing module 114 may perform testing on the mobile devices 112 that does not require a human presence.

The mobile devices 112 may transmit uplink communication signals as part of the testing performed by the testing module 114. The uplink communication signals may be RF signals. The RF controlled environment antenna 108 may receive the uplink communication signals from the mobile devices 112. As discussed above, the received uplink communication signals may be amplified by the bidirectional amplifier 106 and then broadcast to one or more base stations 102 by the rotating unidirectional antenna 104. The testing module 114 may monitor the uplink and downlink communication signals by communicating with the RF controlled environment antenna 108.

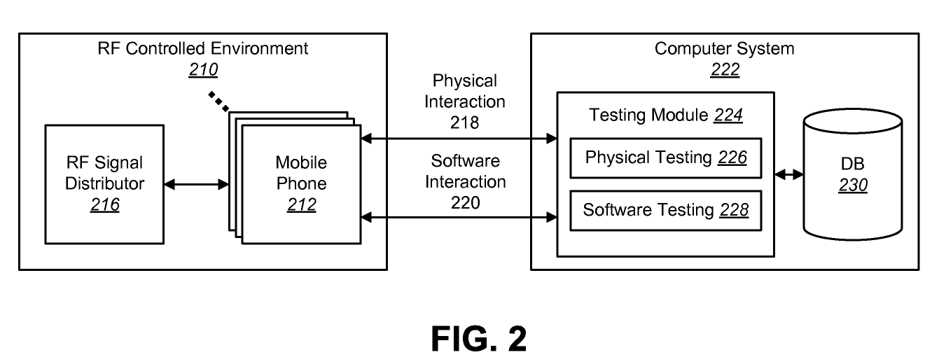

FIG. 2 is a block diagram of an RF controlled environment 210 and a computer system 222. The RF controlled environment 210 may be used as the RF controlled environment 110 in the automated mobile device testing system 100 of FIG. 1. The computer system 222 may also be included in the automated mobile device testing system 100 of FIG. 1.

The automated mobile device testing system 100 may include an RF signal distributor 216. The RF signal distributor 216 may distribute RF signals to one or more mobile phones 212 within the RF controlled environment 210. The RF signal distributor 216 may be located within the RF controlled environment 210. Alternatively, the RF signal distributor 216 may be located outside of the RF controlled environment 210. The RF signal distributor 216 may be an antenna, such as an RF controlled environment antenna 108, that distributes the RF signals to the mobile phones. Alternatively, the RF signal distributor 216 may distribute the RF signals to the mobile phones 212 using wired means.

The RF signal distributor 216 may also receive RF signals from the mobile phones 212. The RF signal distributor 216 may receive RF signals from the mobile phones 212 over wired or wireless means. For example, if the RF signal distributor 216 is an antenna, the RF signal distributor 216 may receive broadcast RF signals from the mobile phones 212.

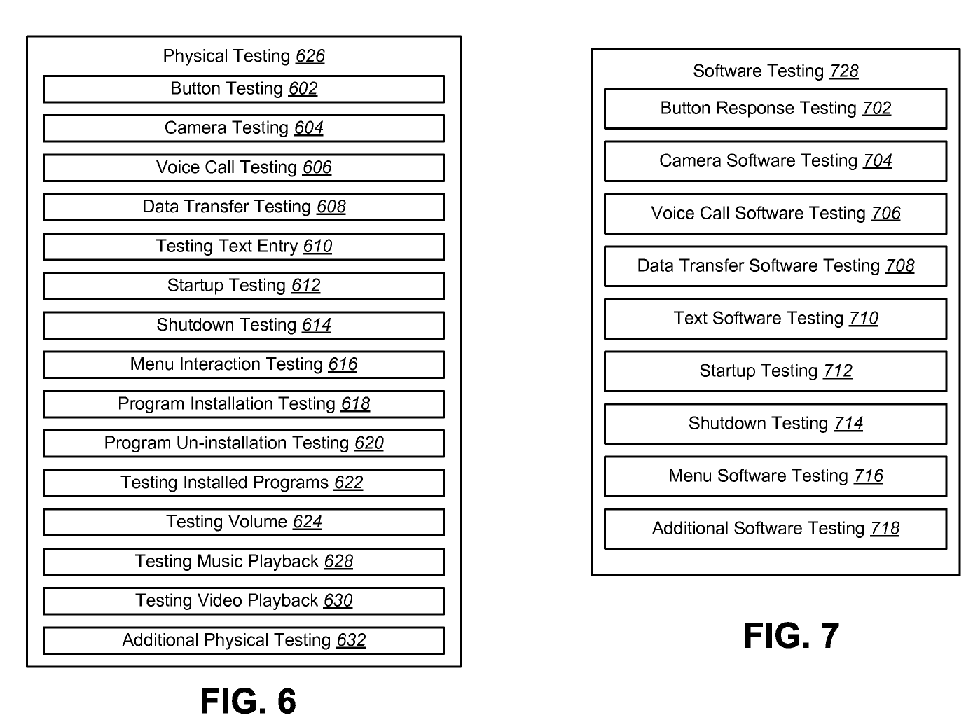

The automated mobile device testing system 100 may also include a computer system 222. The computer system 222 may control the testing of the mobile phones 212. The computer system 222 may include a testing module 224. The testing module 224 may include physical testing 226 and software testing 228 to be performed on the mobile phones 212 in the RF controlled environment 210. Physical testing 226 is discussed in more detail below in relation to FIG. 6. Software testing 228 is discussed in more detail below in relation to FIG. 7.

The testing module 224 may perform physical testing 226 on the mobile phones 212 in the RF controlled environment 210 using physical interaction 218 with the mobile phones 212. Physical interaction 218 may include the use of electro-mechanical key-pressers and/or the use of pneumatic key-pressers. Physical interaction 218 may simulate user interaction with the mobile phones 212. For example, physical interaction 218 may include pressing keys on a mobile phone 212 as if the keys were pressed by an end-user.

The testing module 224 may perform software testing 228 on the mobile phones 212 in the RF controlled environment 210 using software interaction 220 with the mobile phones 212. Software interaction 220 may include starting and stopping software programs that run on a mobile phone 212. Software interaction 220 may also include detection and/or interaction with software processes that run on a mobile phone 212.

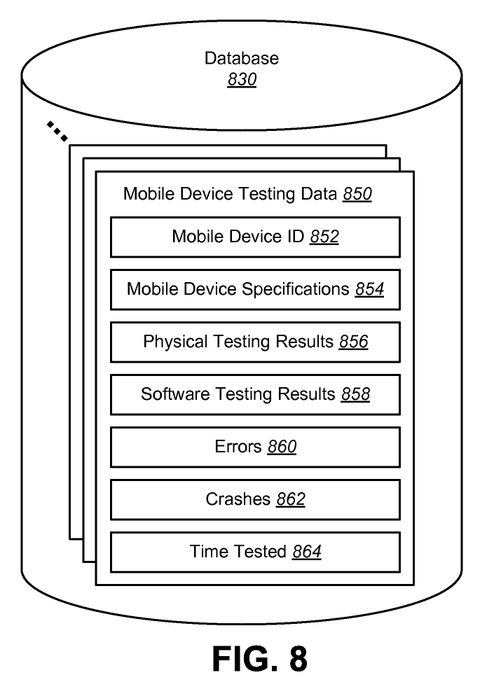

The testing module 224 may record the tests performed on the mobile phones 212 and the results obtained from the tests onto a database 230 on the computer system 222. The database 230 is discussed in further detail below in relation to FIG. 8.

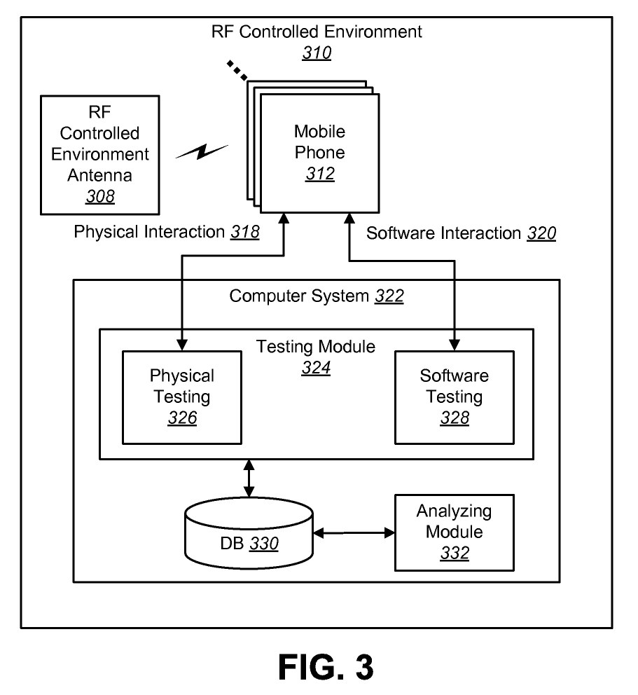

FIG. 3 is a block diagram illustrating an alternate RF controlled environment 310. The RF controlled environment 310 may be used as the RF controlled environment 110 in the automated mobile device testing system 100 of FIG. 1.

The automated mobile device testing system 100 may include an RF controlled environment 310. The RF controlled environment 310 may include an RF controlled environment antenna 308. The RF controlled environment antenna 308 may be in wireless communication with one or more mobile phones 312 within the RF controlled environment 310. The RF controlled environment antenna 308 may broadcast RF signals to the mobile phones 312 and receive RF signals from the mobile phones 312.

The automated mobile device testing system 100 may also include a computer system 322. The computer system 322 may be located within the RF controlled environment 3 10. The computer system 322 may include a testing module 324. The testing module 324 may perform physical testing 326 on the mobile phones 312 using physical interaction 318. The testing module 324 may perform software testing 328 on the mobile phones 312 using software interaction 320.

The testing module 324 may perform testing on a mobile phone 312 without user interaction. For example, the testing module 324 may perform automated testing on a mobile phone 312 that simulates testing of the mobile phone 312 by an engineer. The automated testing on a mobile phone 312 may emulate real-time field mobility conditions for the mobile phone 312. Stability requirements may be tested continuously over periods in excess of 24 hours without stopping or reducing testing during evenings, weekends, and holidays. The testing module 324 may record the results of the testing on a database 330 located on the computer system 322. The computer system 324 may analyze the results of the testing with an analyzing module 332.

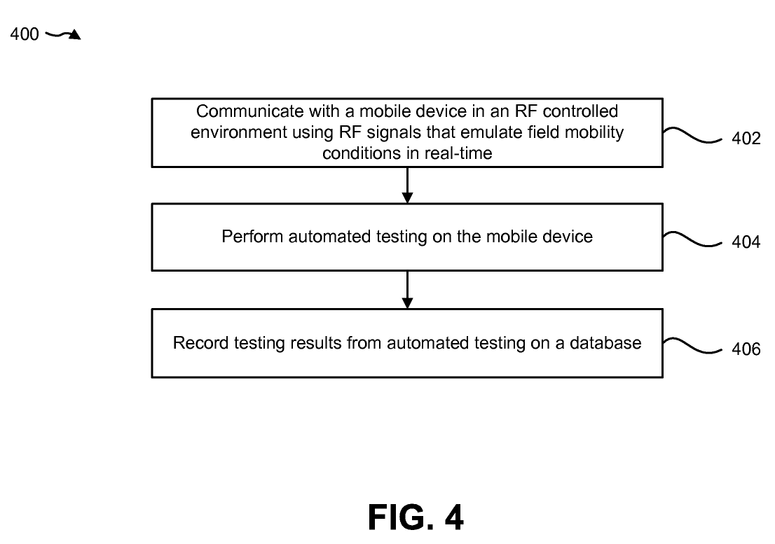

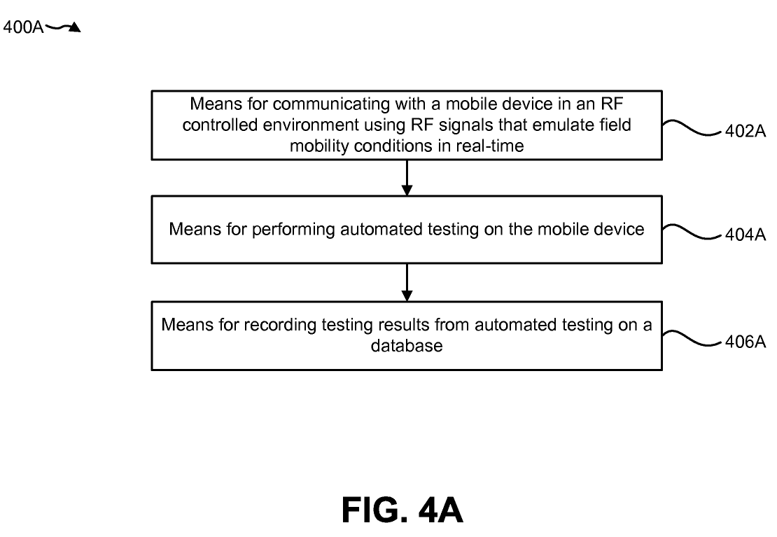

FIG. 4 is a flow diagram illustrating a method 400 for automated testing of a mobile device 112 with field mobility conditions in real-time. An automated mobile device testing system 100 may communicate 402 with a mobile device 112 in an RF controlled environment 110 using RF signals that emulate field mobility conditions in real-time. The automated mobile device testing system 100 may communicate 402 with the mobile device 112 using an RF controlled environment antenna 308. Alternatively, the automated mobile device testing system 100 may communicate with the mobile device 112 using an RF distributor 216.

The automated mobile device testing system 100 may then perform 404 automated testing on the mobile device 112. The automated testing may include physical testing 326 and software testing 328. Automated testing may be performed using physical interaction 318 and/or software interaction 320. The automated mobile device testing system 100 may then record 406 testing results from the automated testing onto a database 130.

The method 400 of FIG. 4 described above may be performed by various hardware and/or software component(s) and/or module(s) corresponding to the means-plus-function blocks 400A illustrated in FIG. 4A. In other words, blocks 402 through 406 illustrated in FIG. 4 correspond to means-plus-function blocks 402A through 406A illustrated in FIG. 4A.

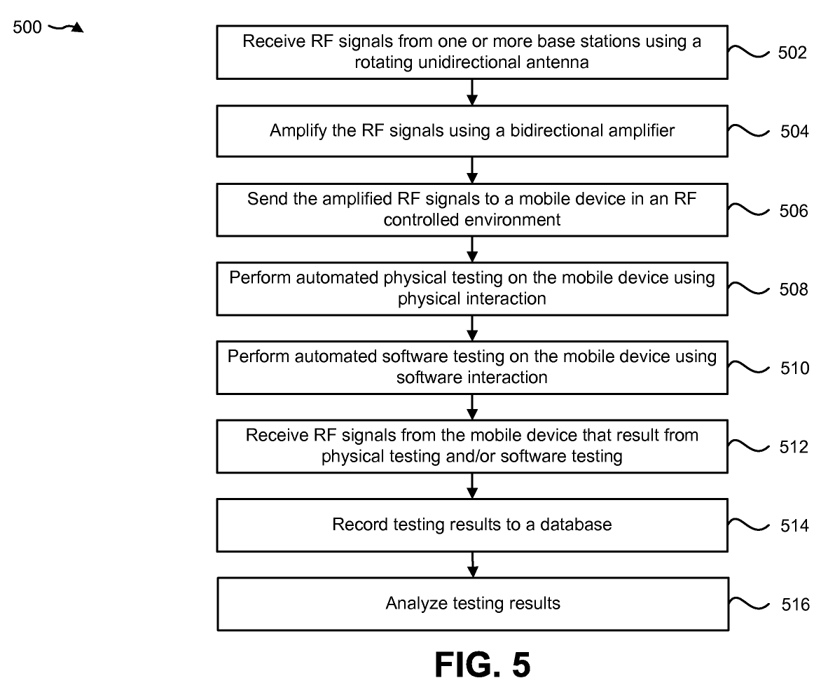

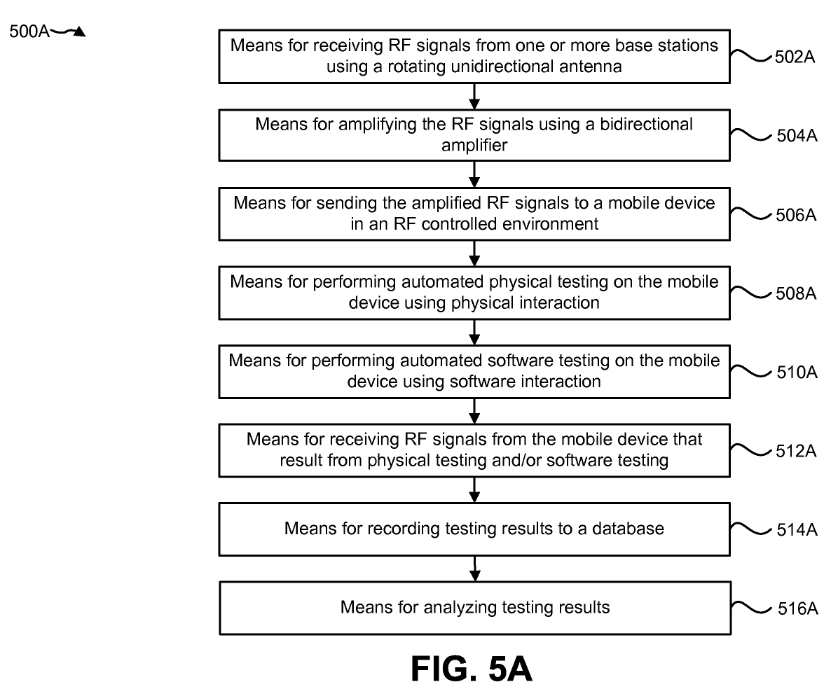

FIG. 5 is a flow diagram of a more detailed method 500 for automated testing of a mobile device 112 with field mobility conditions in real-time. An automated mobile device testing system 100 may receive 502 RF signals from one or more base stations 102. The RF signals may emulate field mobility conditions. For example, the RF signals may emulate a mobile device 112 traveling in a vehicle; the mobile device 112 may experience signal fading, handoffs, and other real-world conditions. The RF signals may emulate field mobility conditions in real-time with the use of rotating unidirectional antennas 104. The automated mobile device testing system 100 may amplify 504 the RF signals using a bidirectional amplifier 106. The automated mobile device testing system 100 may then send 506 the amplified RF signals to a mobile device 112 in an RF controlled environment 110.

The automated mobile device testing system 100 may perform 508 automated physical testing 226 on the mobile device 112 using automated physical interaction 218. The automated mobile device testing system 100 may also perform 510 automated software testing 228 on the mobile device 112 using automated software interaction 220. The physical interaction 218 and software interaction 220 may cause the mobile device 112 to broadcast RF signals. The automated mobile device testing system 100 may receive 512 these RF signals from the mobile device 112 that result from the automated physical interaction 218 and/or the automated software interaction 220. The automated mobile device testing system 100 may then record 514 the testing results to a database 230. The automated mobile device testing system 100 may further analyze 516 the testing results.

The method 500 of FIG. 5 described above may be performed by various hardware and/or software component(s) and/or module(s) corresponding to the means-plus-function blocks 500A illustrated in FIG. 5A. In other words, blocks 502 through 516 illustrated in FIG. 5 correspond to means-plus-function blocks 502A through 516A illustrated in FIG. 5A.

FIG. 6 is a block diagram illustrating various physical testing 626 that the automated mobile device testing system 100 may perform on a mobile device 112. The physical testing 626 shown in FIG. 6 may be the physical testing 226 performed by the testing module 224 in the computer system 222 of FIG. 2.

Physical testing 626 may be performed by the automated mobile device testing system 100 using physical interaction 218 with a mobile device 112. Physical testing 626 may interact with software testing 228 to produce testing results such as mobile device testing data. Mobile device testing data is discussed in more detail below in relation to FIG. 8. The automated mobile device testing system 100 may physically interact 218 with a mobile device 112 by using a mechanical key-presser to press the keys on the mobile device 112 as if an end-user is pressing the keys. The key-presser may thus emulate an end-user using the mobile device 112 without the need for human intervention. The key-presser may be an electromechanical key-presser or a pneumatic key-presser. The automated mobile device testing system 100 may also physically interact 218 with a mobile device 112 using a microphone, a speaker, and/or a visual detector. The microphone may be used to detect audio output from the mobile device 112. The speaker may be used to transmit audio input to the mobile device 112. The visual detector may be used to determine whether the display on a mobile device 112 is functioning properly.

The automated mobile device testing system 100 may physically interact 218 with the mobile device 112, thereby testing the features of the mobile device 112 from the perspective of an end-user. The physical testing 626 may perform button testing 602 on the mobile device 112 input buttons. The mobile device 112 input buttons may be subject to varying degrees of force over long periods of time as part of the physical testing 626 to ensure that the mobile device 112 input buttons can handle the levels of force that an end-user may apply to the mobile device 112.

Another feature that the physical testing 626 may check is a camera on the mobile device 112. The physical testing 626 may perform camera testing 604 on the mobile device 112 to ensure that the camera is working properly. Camera testing 604 may include pressing the buttons to enter and exit camera mode, pressing the buttons to take pictures of an object with the camera, comparing the display of pictures with the photographed object, and pressing the buttons to take video with the camera. The buttons may be pressed by an automated key-presser.

Another feature that the physical testing 626 may test is voice calls. The physical testing 626 may perform voice call testing 606 on the mobile device 112 to ensure that the mobile device 112 can send and receive audible voice calls. Voice call testing 606 may include pressing the buttons on the mobile device 112 to initiate a voice call, end a voice call, accept a voice call, and switch from a voice call to another function such as call waiting or accessing the mobile device 112 phonebook. Voice call testing 606 may also include testing the playback of received voice data using a microphone to receive the audio output of the mobile device 112. Voice call testing 606 may further include testing the sending of voice data using a speaker to input audio into the mobile device 112.

The physical testing 626 may also test data transfers. The physical testing 626 may perform data transfer testing 608 on the mobile device 112 to ensure that the mobile device 112 can send and receive data transfers such as text messages, picture files, and program files with reasonable accuracy and download speed. The physical testing 626 may further test the entry of text 610 to the mobile device 112. The physical testing 626 may press the buttons on the mobile device 112 to simulate end-user entry of text, including the use of predictive text, as part of testing text entry 610.

The physical testing 626 may also perform startup testing 612 and shutdown testing 614 on the mobile device 112. Startup testing 612 may include turning the mobile device 112 on using the on button. Shutdown testing 614 may include turning the mobile device 112 off using the off button. Shutdown testing 614 may include turning the mobile device 112 off while programs on the mobile device 112 are running. The physical testing 626 may further include menu interaction testing 616. Menu interaction testing 616 may include navigating through the menu functions on the mobile device 112 using the key-pressers to ensure that the menu functions work properly.

The physical testing 626 may also include program installation testing 618 and program un-installation testing 620. Program installation testing 618 may include the downloading and installation of various programs onto the mobile device 112. Program un-installation testing 620 may include uninstalling programs on the mobile device 112. Program installation testing 618 and program un-installation testing 620 may test the ability of the mobile device 112 to download, install, and uninstall various programs. The physical testing 626 may also include testing the installed programs 622. Testing the installed programs 622 may include testing the use of various programs that run simultaneously on the mobile device 112 and testing the interaction of these various programs.

The physical testing 626 may further include testing volume 624, testing music playback 628, and testing video playback 630. The automated mobile device testing system 100 may adjust the volume of the mobile device 112 using the key-pressers to ensure that the volume adjusts properly. The automated mobile device testing system 100 may also start music and/or video playback to ensure that the mobile device 112 is capable of proper music playback and video playback. The physical testing 626 may include additional physical testing 632 not discussed above that involves physical interaction 218 with a mobile device 112.

FIG. 7 is a block diagram illustrating the various software testing 728 that the automated mobile device testing system 100 may perform on a mobile device 112. The software testing 728 shown in FIG. 7 may be the software testing 228 performed by the testing module 224 in the computer system 222 of FIG. 2.

Software testing 728 may interact with physical testing 626 to produce testing results. The testing results may be saved as a mobile device testing data. The automated mobile device testing system 100 may interact with a mobile device 112 for software testing 728 using wired or wireless means. For example, the automated mobile device testing system 100 may initiate software testing 728 on the mobile device 112 and receive software testing results from the mobile device 112 over a cable attached to the mobile device 112. Alternatively, the automated mobile device testing system 100 may initiate software testing 728 on the mobile device 112 and receive software testing results from the mobile device 112 over a wireless connection. Alternatively still, the automated mobile device testing system 100 may initiate software testing 728 on the mobile device 112 and receive software testing results from the mobile device 112 over a combination of both wired and wireless means.

Software testing 728 may include button response testing 702 on a mobile device 112. Button response testing 702 may test whether the appropriate software response occurs when each button on a mobile device 112 is pressed in a variety of situations. The buttons may be pressed using a key-presser. Software testing 728 may also include camera software testing 704. Camera software testing 704 may test whether the camera software is working properly, whether an end-user can gain proper access of the camera software, and whether the pictures and video files are stored properly within the mobile device 112.

Software testing 728 may further include voice call software testing 706 on a mobile device 112. Voice call software testing 706 may initiate voice calls, test encoding procedures (such as OFDMA, CDMA, and TDMA), accept incoming voice calls, and test decoding procedures. Voice call software testing 706 may also test the software functionality of a voice call during a soft-handoff, a hard-handoff, and during a dropped voice call.

Software testing 728 may include data transfer software testing 708 on a mobile device 112. Data transfer software testing 708 may test the capabilities of the mobile device 112 before, during, and after the initiation or acceptance of a data transfer request. Data transfer software testing 708 may check that the proper data is transferred during a data transfer, that the mobile device 112 uses an optimal data transfer rate, and that received data is properly handled by the mobile device 112.

Software testing 728 may also include text software testing 710 on a mobile device 112. Text software testing 710 may include testing whether the mobile device 112 properly handles the reception of input text, including the use of predictive text and spell checking. Software testing 728 may further include startup testing 712 and shutdown testing 714. Startup testing 712 may test whether the proper procedures are followed by the mobile device 112 during startup such as base station 102 acquisition, checking for available downloads from the base station 102, and enabling the proper features for the mobile device 112. Shutdown testing 714 may test whether the proper procedures are followed by the mobile device 112 during shutdown such as ending programs running on the mobile device 112, aborting voice calls and data transfers, and disabling all features on the mobile device 112 such as the camera and music player.

Software testing 728 may further include menu software testing 716. Menu software testing 716 may test whether the menu functions on the mobile device 112 are working properly. This may include testing the software processes to ensure that menu functions do not lock up or lead to the wrong destination. Menu software testing 716 may test the menu software during many different situations (such as during a voice call or data transfer) to ensure that the menu software will always function properly. Software testing 728 may include additional software testing 718 not mentioned above.

FIG. 8 is a block diagram illustrating a database 830 for use in the present systems and methods. The database 830 may be used as the database 230 in the computer system 222 of FIG. 2.

Mobile device testing data 850 received from the testing module 114 may be recorded on the database 850. Mobile device testing data 850 may include a mobile device ID 852 that identifies the mobile device 112 that the mobile device testing data 850 pertains to. The mobile device testing data 850 may also include mobile device specifications 854 for the specific mobile device 112. Mobile device specifications 854 may include the type of the mobile device 112 (such as a mobile phone or a personal digital assistant), the average receive power, the average transmit power, the generation of the mobile device 112, the features of the mobile device 112, the maximum and minimum receive power, the maximum and minimum transmit power, and the multiple access technologies available for the mobile device 112.

Mobile device testing data 850 may also include the physical testing results 856 and software testing results 858. Physical testing results 856 and software testing results 858 may include information about the testing procedures used, a detailed description of any anomalies from the testing, and the testing procedures that netted positive results. Mobile device testing data 850 may also include any errors 860 that occurred during testing. The mobile device testing data 850 may include information about the errors 860 such as the time of the error, the type of error, and the circumstances surrounding the error. Mobile device testing data 850 may also include any crashes 862 that occurred during testing. A crash 862 may include a mobile device 112 pausing, shutting down unexpectedly, or failing to establish a connection with a base station 102. A crash 862 may also include a software program unexpectedly stopping. Mobile device testing data 850 may further include the amount of time tested 864. The amount of time tested 864 may be helpful in determining the reliability/stability of a mobile device 112, the number of crashes 862 per hour that occurred, and the additional amounts of time necessary for testing the mobile device 112.

FIG. 9 is a block diagram of an automated mobile device testing system 900 with a rotating unidirectional antenna 904. The automated mobile device testing system 900 shown in FIG. 9 may be configured similarly to the automated mobile device testing system 100 in FIG. 1, except as shown in FIG. 9 and discussed below.

A rotating unidirectional antenna 904 may include an RF spinner assembly 970. The RF spinner assembly 970 may include a unidirectional antenna 976 that receives a signal based on what is in the line of sight of the unidirectional antenna 976. The unidirectional antenna 976 may be configured to receive signals from one or more base stations 902. In one configuration, the unidirectional antenna 976 may receive signals over a 20° angle.

The unidirectional antenna 976 may also be configured to send signals to one or more base stations 902. A spinner motor 972 may rotate the RF spinner assembly 970 at a rotation speed 974. The rotation speed 974 may be adjusted to optimize the performance of an automated mobile device testing system 900. As the RF spinner assembly 970 rotates, the unidirectional antenna 976 may receive signals from different base stations 902. The RF spinner assembly 970 thus emulates field mobility conditions including cell reselection, fading, hard handoffs, and soft handoffs in real-time.

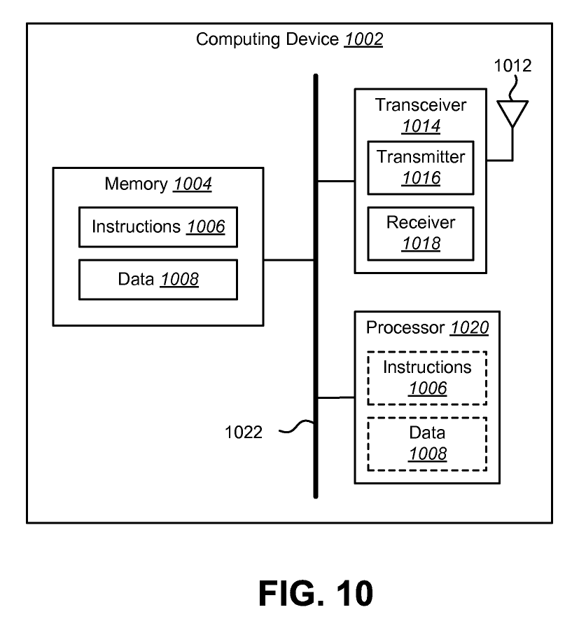

FIG. 10 illustrates certain components that may be included within a computing device 1002 that may be used within the present systems and methods. The computing device 1002 may be a mobile device 112, a computer system 222, a base station 102, or the like.

The computing device 1002 includes a processor 1020. The processor 1020 may be a general purpose single- or multi-chip microprocessor (e.g., an ARM), a special purpose microprocessor (e.g., a digital signal processor (DSP)), a microcontroller, a programmable gate array, etc. The processor 1020 may be referred to as a central processing unit (CPU). The computing device 1002 may also use a combination of processors (e.g., an ARM and DSP).

The computing device 1002 also includes memory 1004. The memory 1004 may be any electronic component capable of storing electronic information. The memory 1004 may be embodied as random access memory (RAM), read only memory (ROM), magnetic disk storage media, optical storage media, flash memory devices in RAM, on-board memory included with the processor, EPROM memory, EEPROM memory, registers, and so forth, including combinations thereof.

Data 1008 and instructions 1006 may be stored in the memory 1004. The instructions 1006 may be executable by the processor 1020 to implement the methods disclosed herein. Executing the instructions 1006 may involve the use of the data 1008 that is stored in the memory 1004.

The computing device 1002 may also include a transmitter 1016 and a receiver 1018 to allow transmission and reception of signals between the computing device 1002 and a remote location. The transmitter 1016 and receiver 1018 may be collectively referred to as a transceiver 1014. An antenna 1012 may be electrically coupled to the transceiver 1014. The computing device 1002 may also include (not shown) multiple transmitters, multiple receivers, multiple transceivers and/or multiple antenna.

The various components of the computing device 1002 may be coupled together by one or more buses, which may include a power bus, a control signal bus, a status signal bus, a data bus, etc. For the sake of clarity, the various buses are illustrated in FIG. 10 as a bus system 1022.

In the above description, reference numbers have sometimes been used in connection with various terms. Where a term is used in connection with a reference number, this is meant to refer to a specific element that is shown in one or more of the Figures. Where a term is used without a reference number, this is meant to refer generally to the term without limitation to any particular Figure.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

The term “processor” should be interpreted broadly to encompass a general purpose processor, a central processing unit (CPU), a microprocessor, a digital signal processor (DSP), a controller, a microcontroller, a state machine, and so forth. Under some circumstances, a “processor” may refer to an application specific integrated circuit (ASIC), a programmable logic device (PLD), a field programmable gate array (FPGA), etc. The term “processor” may refer to a combination of processing devices, e.g., a combination of a DSP and a microprocessor, a plurality of microprocessors, one or more microprocessors in conjunction with a DSP core, or any other such configuration.

The term “memory” should be interpreted broadly to encompass any electronic component capable of storing electronic information. The term memory may refer to various types of processor-readable media such as random access memory (RAM), read-only memory (ROM), non-volatile random access memory (NVRAM), programmable read-only memory (PROM), erasable programmable read only memory (EPROM), electrically erasable PROM (EEPROM), flash memory, magnetic or optical data storage, registers, etc. Memory is said to be in electronic communication with a processor if the processor can read information from and/or write information to the memory. Memory that is integral to a processor is in electronic communication with the processor.

The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may comprise a single computer-readable statement or many computer-readable statements.

The functions described herein may be implemented in hardware, software, firmware, or any combination thereof. If implemented in software, the functions may be stored as one or more instructions on a computer-readable medium. The term “computer-readable medium” refers to any available medium that can be accessed by a computer. By way of example, and not limitation, a computer-readable medium may comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray® disc where disks usually reproduce data magnetically, while discs reproduce data optically with lasers.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

Further, it should be appreciated that modules and/or other appropriate means for performing the methods and techniques described herein, such as those illustrated by FIGS. 4 and 5, can be downloaded and/or otherwise obtained by a device. For example, a device may be coupled to a server to facilitate the transfer of means for performing the methods described herein. Alternatively, various methods described herein can be provided via a storage means (e.g., random access memory (RAM), read only memory (ROM), a physical storage medium such as a compact disc (CD) or floppy disk, etc.), such that a device may obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the systems, methods, and apparatus described herein without departing from the scope of the claims.

What is claimed is:

1. An apparatus for automated mobile device testing, comprising:
a processor;
memory in electronic communication with the processor;
instructions stored in the memory, the instructions being executable to:
communicate with a mobile device in a radio frequency (RF) controlled environment using RF signals that emulate field mobility conditions in real-time;
perform automated testing on the mobile device; and
record testing results from the automated testing in a database.

2. The apparatus of claim 1, further comprising a rotating unidirectional antenna that receives the RF signals that emulate field mobility conditions in real-time.

3. The apparatus of claim 1, wherein the instructions are also executable to analyze the testing results to determine the stability of the mobile device.

4. The apparatus of claim 1, wherein the RF controlled environment is an environment where only certain RF signals are present.

5. The apparatus of claim 1, further comprising an RF controlled environment antenna, wherein communicating with the mobile device is accomplished using the RF controlled environment antenna within the RF controlled environment.

6. The apparatus of claim 1, wherein the automated testing on the mobile device is performed using physical interaction.

7. The apparatus of claim 1, wherein the automated testing on the mobile device is performed using software interaction.

8. The apparatus of claim 1, further comprising an RF signal distributor.

9. The apparatus of claim 1, further comprising a bidirectional amplifier.

10. A method for automated mobile device testing, comprising:
communicating with a mobile device in a radio frequency (RF) controlled environment using RF signals that emulate field mobility conditions in real-time;
performing automated testing on the mobile device; and
recording testing results from the automated testing in a database.

11. The method of claim 10, wherein the RF signals that emulate field mobility conditions in real-time are received from one or more base stations using a rotating unidirectional antenna.

12. The method of claim 10, further comprising analyzing the testing results to determine the stability of the mobile device.

13. The method of claim 10, wherein the RF controlled environment is an environment where only certain RF signals are present.

14. The method of claim 10, wherein communicating with the mobile device in the RF controlled environment is accomplished using an RF controlled environment antenna within the RF controlled environment.

15. The method of claim 10, wherein the automated testing on the mobile device is performed using physical interaction.

16. The method of claim 15, wherein the physical interaction simulates user interaction with the mobile device.

17. The method of claim 10, wherein the automated testing on the mobile device is performed using software interaction.

18. An apparatus for automated mobile device testing, comprising:
means for communicating with a mobile device in a radio frequency (RF) controlled environment using RF signals that emulate field mobility conditions in real-time;
means for performing automated testing on the mobile device; and
means for recording testing results from the automated testing in a database.

19. A computer-program product for automated mobile device testing, the computer-program product comprising a computer-readable medium having instructions thereon, the instructions comprising:
code for communicating with a mobile device in a radio frequency (RF) controlled environment using RF signals that emulate field mobility conditions in real-time;
code for performing automated testing on the mobile device; and
code for recording testing results from the automated testing in a database.

20. An automated mobile device testing system, the automated mobile device testing system comprising:
one or more base stations for serving one or more mobile devices;
a rotating unidirectional antenna;
a radio frequency (RF) controlled environment;
one or more mobile devices to be tested; and
automated testing equipment.

21. The system of claim 20, wherein the automated testing equipment simulates user interaction with the one or more mobile devices to be tested.

22. The system of claim 20, wherein the automated testing equipment performs physical testing.

23. The system of claim 20, wherein the automated testing equipment performs software testing.
